(19) United States
(12) Patent Application Publication
(10) Pub. No.: US 2022/0172114 A1
(43) Pub. Date: Jun. 2, 2022

(54) MACHINE LEARNING DEVICE, DETERIORATION ESTIMATOR, AND DETERIORATION DIAGNOSIS DEVICE

(71) Applicant: NIPPON TELEGRAPH AND TELEPHONE CORPORATION, Tokyo (JP)

(72) Inventors: Takashi GOTO, Musashino-shi, Tokyo (JP); Tomoya SHIMIZU, Musashino-shi, Tokyo (JP); Yukihiro GOTO, Musashino-shi, Tokyo (JP)

(73) Assignee: NIPPON TELEGRAPH AND TELEPHONE CORPORATION, Tokyo (JP)

(21) Appl. No.: 17/437,168

(22) PCT Filed: Feb. 27, 2020
(86) PCT No.: PCT/JP2020/007911

§ 371 Date: Sep. 8, 2021

(30) Foreign Application Priority Data
Mar. 12, 2019 (JP) 2019-044532

(51) Int. Cl. G06N 20/00; G06Q 10/00

(52) U.S. Cl. CPC G06N 20/00; G06Q 10/20

(57) ABSTRACT

A machine learning device, a deterioration estimation device, and a deterioration diagnostic apparatus capable of estimating a deterioration state of a non-inspected outside facility without dispatching a technician to the site are provided. A machine learning device 301 according to the present invention generates a learning model M1 by which a computer determines deterioration of an outside facility and includes an input unit 11 to which facility data D1 representing features and states of the outside facility and deterioration data D2 representing presence or absence of deterioration that has occurred in the outside facility are input, and an analysis unit 12 which generates the learning model M1 by performing supervised learning using the facility data of the outside facility in a deterioration state and the facility data of the outside facility that is not in a deterioration state as training data.

### TECHNICAL FIELD

The present disclosure relates to a machine learning device, a deterioration estimation device, and a deterioration diagnostic apparatus for estimating a facility state using machine learning.

### BACKGROUND ART

Currently, maintenance work for outside facilities such as utility poles, such as deterioration diagnosis, is performed in such a manner that a technician goes to the site and executes visual inspection. A method of 3D-modeling an outdoor structure such as a utility pole or a cable from 3-dimensional coordinates obtained using a mobile mapping system (hereinafter, MMS), 3-dimensionally reproducing a current state and the like of the outdoor structure in a PC, and estimating deterioration is also being examined (refer to PTL 1, for example).

### CITATION LIST

### Patent Literature

[PTL 1] Japanese Patent Application Publication No. 2015-78849

### SUMMARY OF THE INVENTION

### Technical Problem

In the technique such as in PTL 1, it is necessary to approach an outside facility using a vehicle or the like, perform measurement using a sensor, and collect data according to dispatch of a technician to the site. Accordingly, the conventional technology has problems that time and costs are incurred to inspect all outside facilities within a management zone.

Therefore, to solve the aforementioned problems, an object of the present invention is to provide a machine learning device, a deterioration estimation device, and a deterioration diagnostic apparatus capable of estimating a deterioration state of a non-inspected outside facility without dispatching a technician to the site.

### Means for Solving the Problem

To accomplish the aforementioned object, a machine learning device, a deterioration estimation device, and a deterioration diagnostic apparatus according to the present invention generate a learning model through machine learning using facility data (specific explanatory variables) and deterioration conditions of an examined outside facility as training data and estimate deterioration states of other non-inspected outside facilities using the learning model.

Specifically, the machine learning device according to the present invention is a machine learning device that generates a learning model by which a computer determines deterioration of an outside facility, the machine learning device including: an input unit to which facility data representing features and states of the outside facility and deterioration data representing presence or absence of deterioration that has occurred in the outside facility are input; and an analysis unit which generates the learning model by performing supervised learning using the facility data of the outside facility in a deterioration state and the facility data of the outside facility that is not in a deterioration state as training data, wherein the facility data is at least one of the number of years elapsed from when the outside facility was installed, the number of support wires supporting the outside facility, classification representing an arrangement state of the adjacent outside facility, the length of the outside facility, and information on an area where the outside facility is installed.

Furthermore, the deterioration estimation device according to the present invention is a deterioration estimation device in which a computer diagnoses deterioration of a diagnosis target outside facility using a learning model, the deterioration estimation device including: an evaluation data input unit to which facility data for evaluation representing features and states of the diagnosis target outside facility is input; and an evaluation unit which calculates a probability of deterioration of the diagnosis target outside facility from the facility data for evaluation input to the evaluation data input unit using the learning model, wherein the learning model is generated through supervised learning using facility data of an outside facility other than the diagnosis target in a deterioration state and facility data of the outside facility other than the diagnosis target which is not in a deterioration state as training data, and the facility data is at least one of the number of years elapsed from when the outside facility was installed, the number of support wires supporting the outside facility, classification representing an arrangement state of the adjacent outside facility, the length of the outside facility, and information on an area where the outside facility is installed.

The deterioration diagnostic apparatus according to the present invention includes the machine learning device and the deterioration estimation device using the learning model generated by the machine learning device.

The machine learning device generates the learning model using facility data highly related to deterioration of a facility. In addition, the deterioration estimation device can predict an outside facility expected to deteriorate from facility data of non-inspected outside facilities using the generated learning model. Here, it is possible to considerably reduce the time and cost required to inspect all outside facilities in a management zone by dispatching a technician only to outside facilities predicted to deteriorate.

Accordingly, the present invention can provide a machine learning device, a deterioration estimation device, and a deterioration diagnostic apparatus capable of estimating a deterioration state of a non-inspected outside facility without dispatching a technician to the site.

The accuracy of deterioration prediction is improved by adding data described below.

The facility data may also include a deflection of the outside facility.

Further, at least one of weather data and ground data of a position at which the outside facility is installed may be input to the input unit as external data, and the analysis unit may perform supervised learning using the external data of the outside facility in a deterioration state and the external data of the outside facility that is not in a deterioration state as the training data.

In this case, in the deterioration estimation device according to the present invention, the facility data also includes the deflection of the outside facility. Further, at least one of weather data and ground data of a position at which the outside facility is installed is input to the evaluation data input unit as external data, and the learning model is generated through supervised learning using the external data of the outside facility in a deterioration state and the external data of the outside facility that is not in a deterioration state as the training data.

Meanwhile, the aforementioned inventions can be combined as far as is possible.

### Effects of the Invention

The present invention can provide a machine learning device, a deterioration estimation device, and a deterioration diagnostic apparatus capable of estimating a deterioration state of a non-inspected outside facility without dispatching a technician to the site.

### BRIEF DESCRIPTION OF DRAWINGS

FIG. 1 is a diagram representing definition of parameters.

FIG. 2 is a diagram representing definition of parameters.

FIG. 3 is a diagram representing definition of parameters.

FIG. 4 is a diagram representing definition of parameters.

FIG. 5 is a diagram representing definition of parameters.

FIG. 6 is a diagram representing a machine learning device according to the present invention.

FIG. 7 is a diagram representing the machine learning device according to the present invention.

FIG. 8 is an evaluation result of a learning model generated by the machine learning device according to the present invention.

FIG. 9 is an evaluation result of a learning model generated by the machine learning device according to the present invention.

FIG. 10 is an evaluation result of a learning model generated by the machine learning device according to the present invention.

FIG. 11 is an evaluation result of a learning model generated by the machine learning device according to the present invention.

FIG. 12 is an evaluation result of a learning model generated by the machine learning device according to the present invention.

FIG. 13 is an evaluation result of a learning model generated by the machine learning device according to the present invention.

FIG. 14 is an evaluation result of a learning model generated by the machine learning device according to the present invention.

FIG. 15 is an evaluation result of a learning model generated by the machine learning device according to the present invention.

FIG. 16 is a diagram representing a deterioration estimation unit according to the present invention.

FIG. 17 is a diagram representing a deterioration estimation unit according to the present invention.

FIG. 18 is a diagram representing a machine learning device according to the present invention.

FIG. 19 is a diagram representing effects of the present invention.

FIG. 20 is a diagram representing facility data, deterioration data, and facility data for evaluation.

### DESCRIPTION OF EMBODIMENTS

Embodiments of the present invention will be described with reference to the attached drawings. Embodiments described below are examples of the present invention and the present invention is not limited to the following embodiments. Particularly, although an outside facility is a utility pole in the present embodiment, the outside facility is not limited to a utility pole. Meanwhile, it is assumed that components having the same signs in the present specification and drawings represent the same component.

### Definition

Definitions of parameters of facility data mentioned in the present specification will be specified.

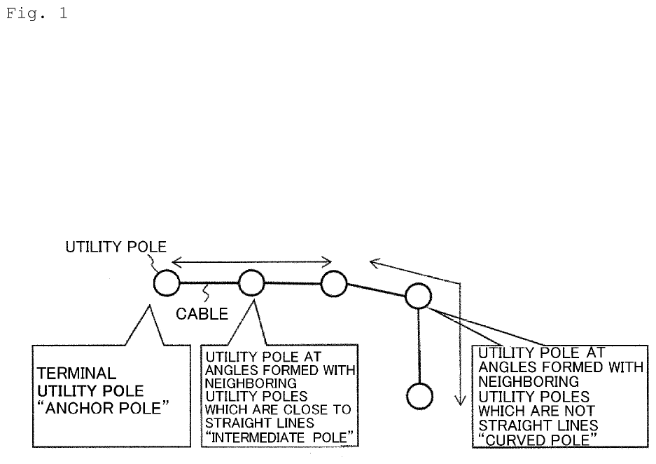

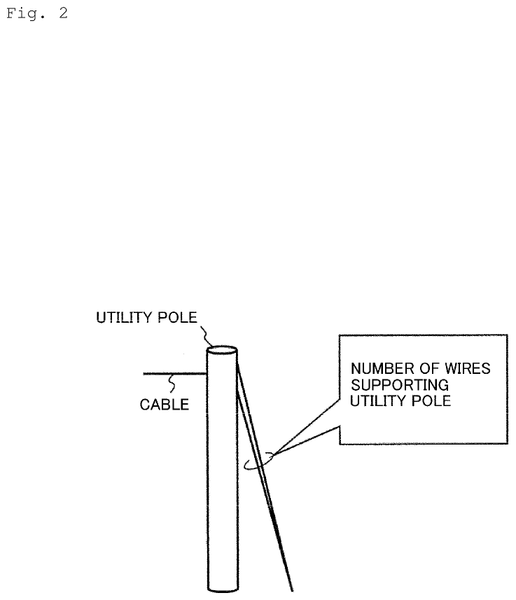

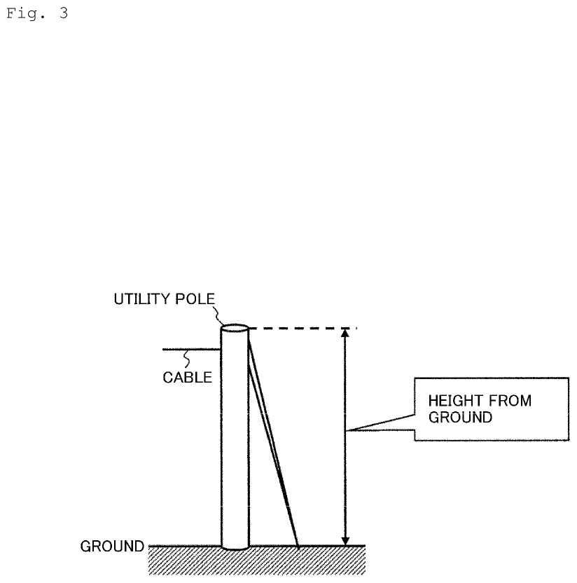

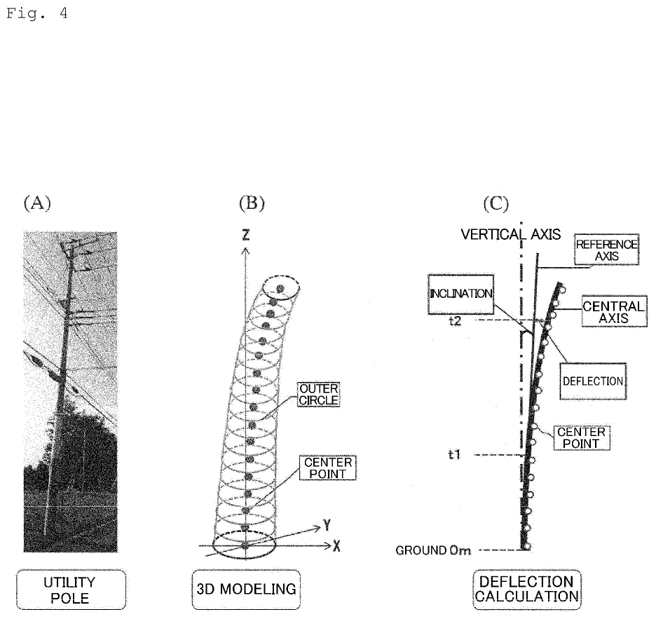

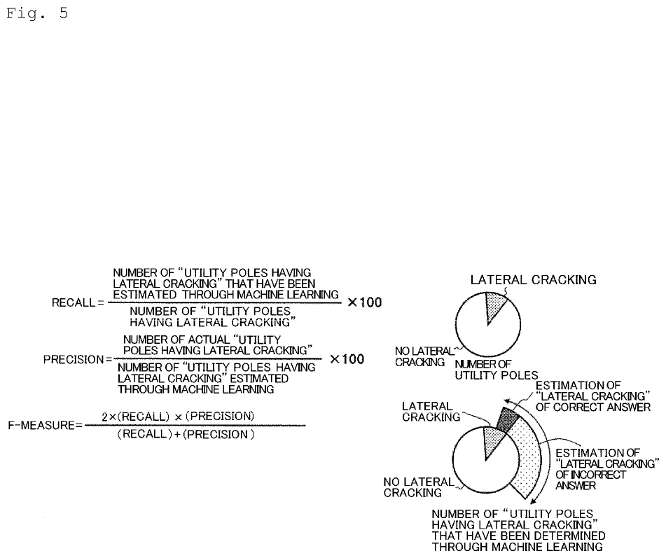

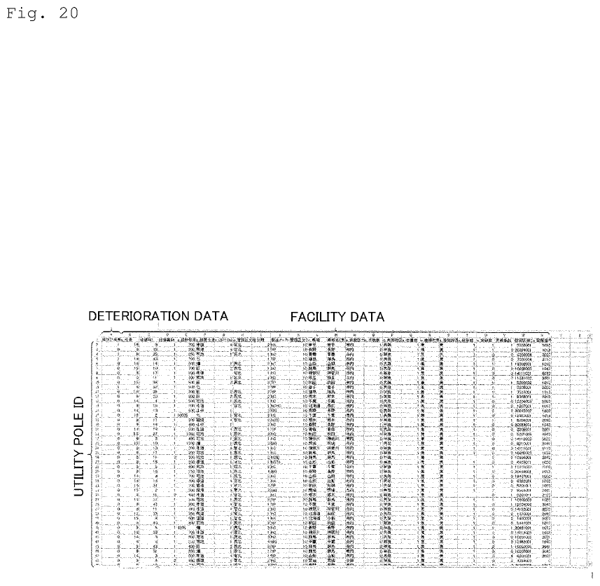

“Pole classification”: Classification in response to an angle between neighboring utility poles, as illustrated in FIG. 1. There are an anchor pole, an intermediate pole, and a curved pole. In an input data example of FIG. 20, “1” is an anchor pole, “2” is an intermediate pole, and “3” is a curved pole.
“Number of support wires”: The number of wires supporting a utility pole, as illustrated in FIG. 2.
“Number of supports”: Although a utility pole is supported by wires in FIG. 2, there are cases in which a utility pole is supported by supports instead of wires. This indicates the number of supports supporting a utility pole.
“Area information”: Information representing a position at which a utility pole is installed. For example, this is the name of a service station that manages utility poles (service area code).
“Pole length”: A height of a utility pole from the ground, as illustrated in FIG. 3.
“Elapsed years”: The number of years from a year when a utility pole was erected at an outside site (started to be used) to the present.
“Installation land type”: The type of a land where a utility pole is installed (e.g., a residential land, a national road, a private road, and the like).
“Design strength”: A design load of a utility pole (e.g., 200, 500, 700 kgf, and the like).
“Public/private classification”: This represents whether the land where a utility pole is installed is public land, private land, or a boundary therebetween.
“Soil type”: The soil type (e.g., ordinary soil, bedrock soil, soft soil, or the like) of a place where a utility pole is installed.
“Manufacturer”: The name of a manufacturer of a utility pole.
“Deflection”: The definition is illustrated in FIG. 4. Outer circles of a utility pole are generated at predetermined intervals (e.g., 4 cm) in the height (Z) direction using 3-dimensional coordinates of a point cloud of the utility pole obtained through an MMS (FIG. 4(B)). Then, coordinates of center points of the outer circles are calculated. An approximate curve (e.g., a third-order approximate curve) of these center point coordinates is set to a central axis of the utility pole (FIG. 4(C)). An approximate straight line with respect to center points from the lowest point of the central axis to a predetermined height t1 (e.g., a height of 2 m from the ground) is set to a reference axis. A distance between a point of the reference axis at a height t2 (e.g., a height of 5 m from the ground) greater than the predetermined height t1 and the central axis is defined as a “deflection”. Meanwhile, an angle between a vertical axis and the reference axis is defined as “inclination”.
“Recall”: A probability that a deterioration estimation device will estimate a utility pole among utility poles actually having lateral cracking as a “utility pole having lateral cracking” when the deterioration of the utility poles is assumed to be lateral cracking (refer to FIG. 5).
“Precision”: A probability that a utility pole actually will have lateral cracking when a utility pole is estimated by the deterioration estimation device to be a “utility pole having lateral cracking” (refer to FIG. 5).
“F-measure”: A harmonic mean of recall and precision (refer to FIG. 5).

### Embodiment 1

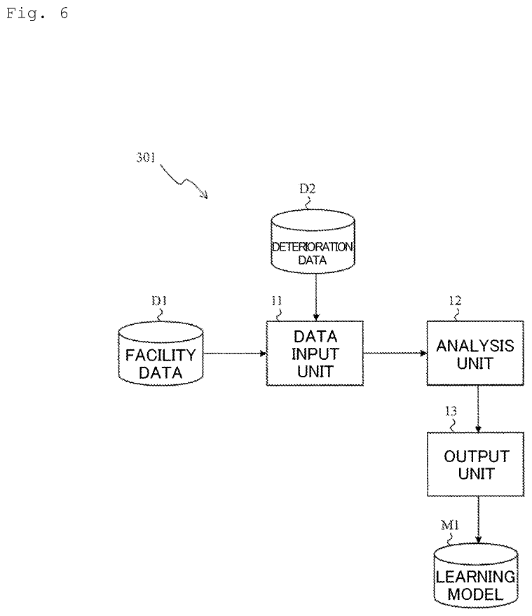

FIG. 6 is a diagram representing a machine learning device 301 of the present embodiment. The machine learning device 301 generates a learning model M1 by which a computer determines deterioration of an outside facility and includes an input unit 11 to which facility data D1 representing features and states of the outside facility and deterioration data D2 representing presence or absence of deterioration that has occurred in the outside facility are input, and an analysis unit 12 which generates the learning model M1 by performing supervised learning using the facility data of the outside facility in a deterioration state and the facility data of the outside facility that is not in a deterioration state as training data.

The facility data D1 is information about the outside facility and information about the surrounding environment of the outside facility. When the outside facility is a utility pole, the facility data D1 may be, for example, at least one of elapsed years, pole classification, the number of support wires, area information, a pole length, a deflection, an installation land type, design strength, the number of supports, public/private classification, soil, and a manufacturer. In addition, the deterioration data D2 is presence or absence of cracking in the case of a concrete utility pole and presence or absence of corrosion in the case of a utility pole made from a steel tube. The facility data D1 can be obtained when a utility pole is installed and the deterioration data D2 is obtained during inspections of a technician up until the current time. FIG. 20 is an example of the facility data D1 and the deterioration data D2 input to the analysis unit 12.

The analysis unit 12 performs feature extraction from the facility data D1 and the deterioration data D2 using an F-measure as follows, generates the learning model M1 and causes an output unit 13 to output the learning model M1.

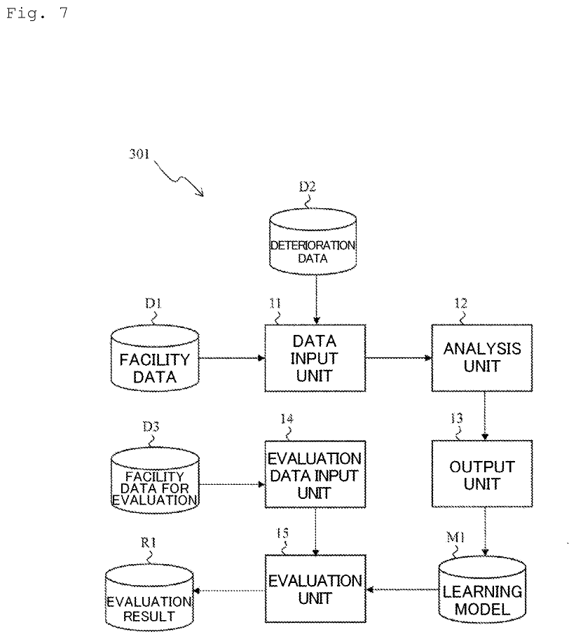

Meanwhile, FIG. 7 is a diagram representing the machine learning device 301 when feature extraction is performed. The machine learning device 301 of FIG. 6 further includes an evaluation data input unit 14 and an evaluation unit 15. Facility data D3 for evaluation is facility data and deterioration data of a utility pole different from the facility data D1. The facility data D3 for evaluation may be, for example, at least two of elapsed years, pole classification, the number of support wires, area information, a pole length, a deflection, an installation land type, design strength, the number of supports, public/private classification, soil, and a manufacturer.

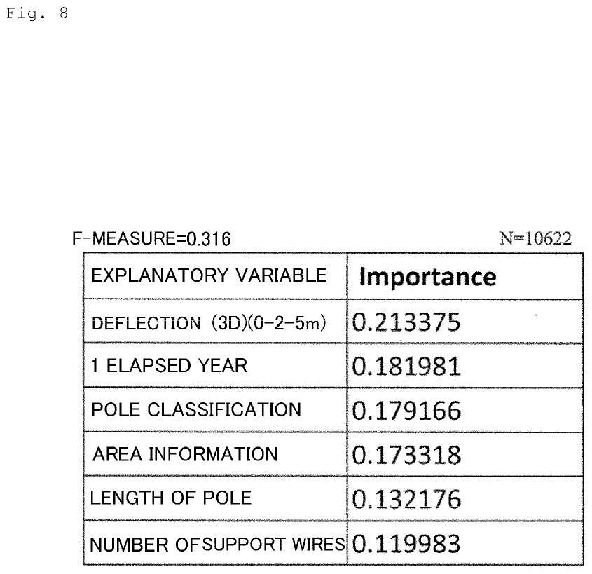

The evaluation data input unit 14 outputs the input facility data D3 for evaluation to the evaluation unit 15. The evaluation unit 15 evaluates the facility data D3 for evaluation using the learning model M1 generated using arbitrary facility data and outputs an evaluation result R1. FIG. 8 to FIG. 15 are results of evaluation performed by the evaluation unit 15. The evaluation unit 15 uses the F-measure as an evaluation value. In addition, the facility data D3 for evaluation is 10,622 pieces of data of utility poles. The facility data D3 for evaluation is data in which the deterioration data of FIG. 20 is not present.

FIG. 8 is an evaluation result of the learning model M1 generated using six types of explanatory variables (deflection, one elapsed year, pole classification, area information, pole length, and the number of support wires in the left-hand-side column of the table) among facility data. An evaluation value (F-measure) of this learning model M1 is 0.316. Meanwhile, the right-hand-side column of the table in FIG. 8 shows a characteristic importance of each explanatory variable and indicates “a degree of influence on the probability of occurrence of cracking calculated by machine learning”. That is, this means that occurrence of cracking is most affected by “deflection”. Meanwhile, in this evaluation, t1=2 m and t2=5 m with respect to “deflection”.

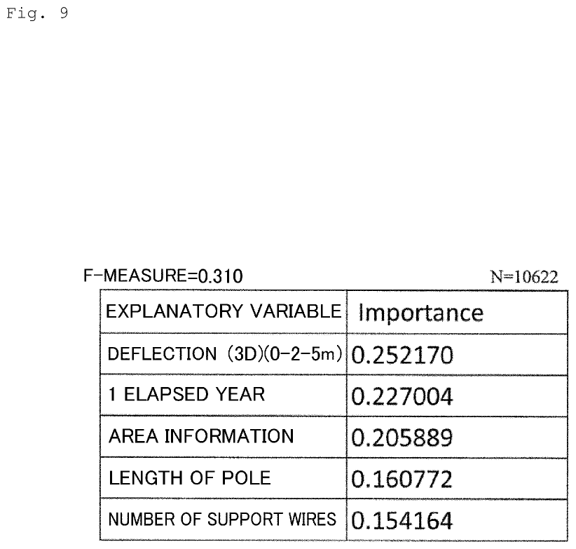

FIG. 9 is an evaluation result of the learning model M1 generated using explanatory variables (five types) excluding “pole classification” from the aforementioned explanatory variables (six types) among the same facility data. An evaluation value (F-measure) of this learning model M1 is 0.310. The learning model M1 (five types of explanatory variables) used in the evaluation of FIG. 9 has an evaluation value (F-measure) lower than that of the learning model (six types of explanatory variables) used in the evaluation FIG. 8. Accordingly, it can be ascertained that the explanatory variable “pole classification” is important for improvement of the accuracy of a learning model of machine learning.

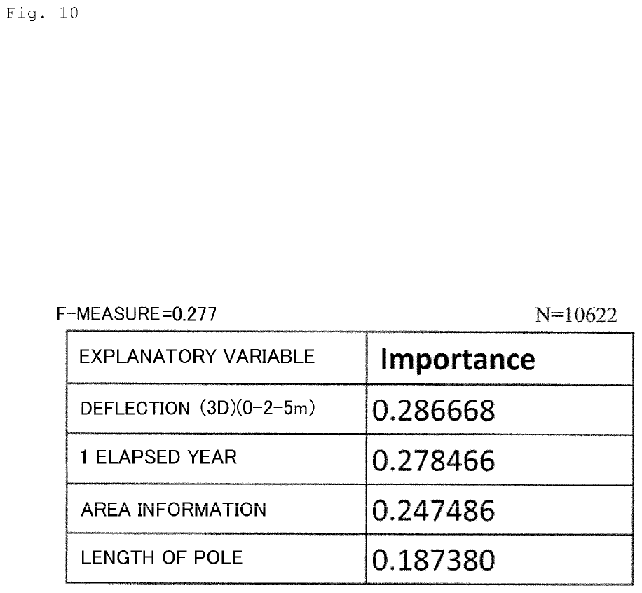

FIG. 10 is an evaluation result of the learning model M1 generated using explanatory variables (four types) excluding “number of support wires” from the aforementioned explanatory variables (five types) among the same facility data. An evaluation value (F-measure) of this learning model M1 is 0.277. The learning model M1 (four types of explanatory variables) used in the evaluation of FIG. 10 has an evaluation value (F-measure) lower than that of the learning model (five types of explanatory variables) used in the evaluation FIG. 9. Accordingly, it can be ascertained that the explanatory variable “number of support wires” is important for improvement of the accuracy of a learning model of machine learning.

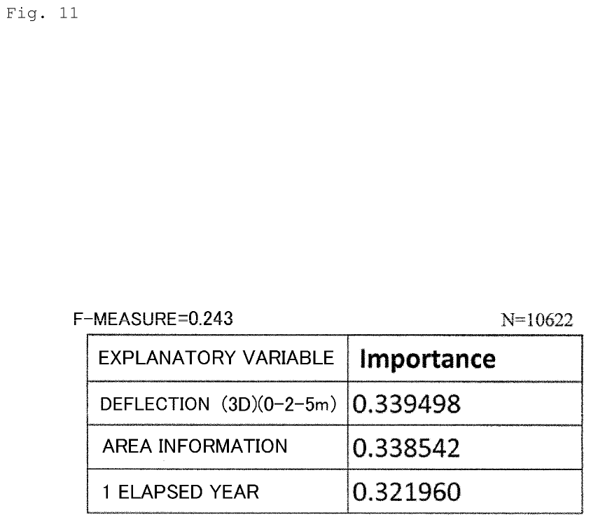

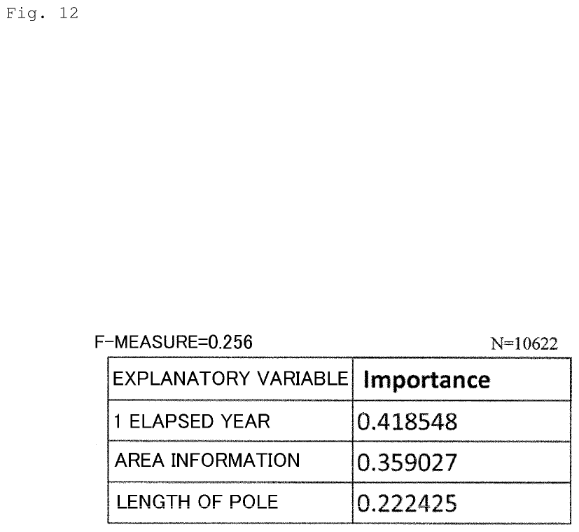

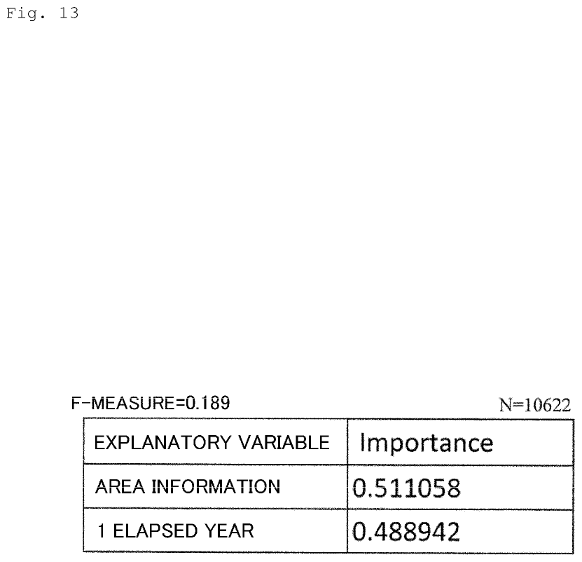

Likewise, FIG. 11 is an evaluation result of the learning model M1 generated using explanatory variables (three types) excluding “pole length”, FIG. 12 is an evaluation result of the learning model M1 generated using explanatory variables (three types) excluding “deflection”, and FIG. 13 is an evaluation result of the learning model M1 generated using explanatory variables (two types) excluding “deflection” and “pole length”. Since all evaluation values (F-measures) in FIG. 11 to FIG. 13 are lower than that in FIG. 10, it can be ascertained that both the explanatory variables “deflection” and “pole length” are important for improvement of the accuracy of a learning model of machine learning.

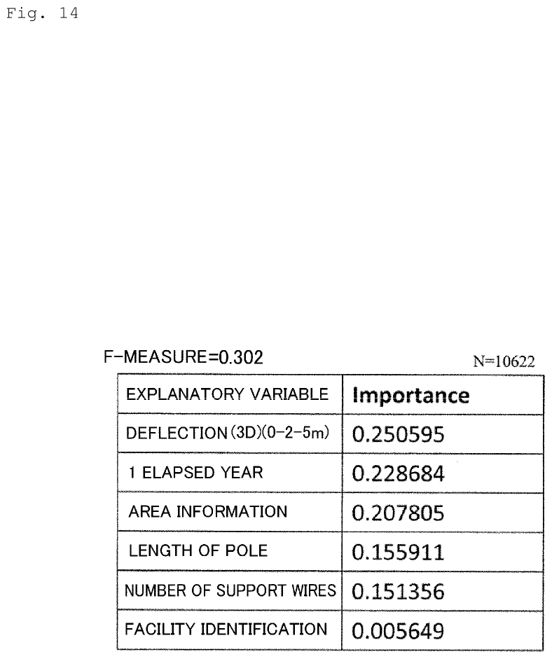

Meanwhile, FIG. 14 is an evaluation result of the learning model M1 generated using explanatory variables (six types) including an explanatory variable “facility identification” in addition to the learning model M1 (five types of explanatory variables) used in the evaluation of FIG. 9. An evaluation value (F-measure) of this learning model M1 is 0.302. The learning model M1 (six types of explanatory variables) used in the evaluation of FIG. 14 has an evaluation value (F-measure) lower than that of the learning model (five types of explanatory variables) used in the evaluation FIG. 9. Accordingly, it can be ascertained that the explanatory variable “facility identification” does not contribute to improvement of the accuracy of a learning model of machine learning.

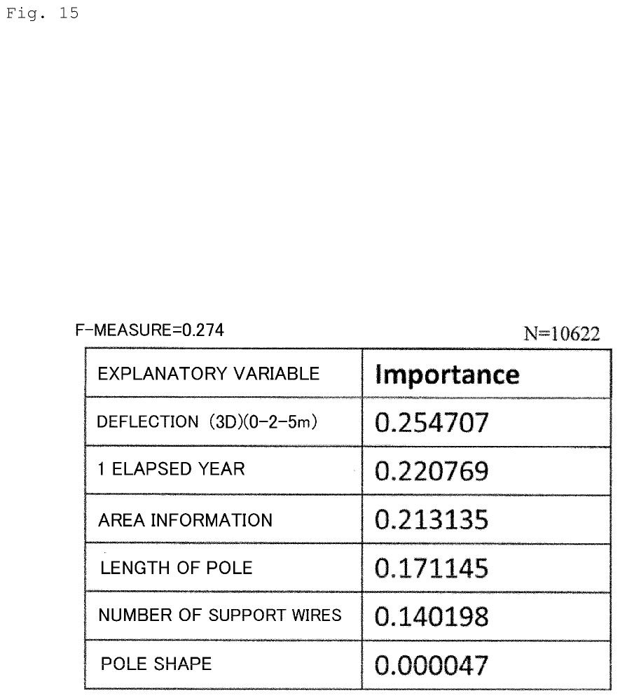

FIG. 15 is an evaluation result of the learning model M1 generated using explanatory variables (six types) including an explanatory variable “pole shape” in addition to the learning model M1 (five types of explanatory variables) used in the evaluation of FIG. 9. An evaluation value (F-measure) of this learning model M1 is 0.274. The learning model M1 (six types of explanatory variables) used in the evaluation of FIG. 15 has an evaluation value (F-measure) lower than that of the learning model (five types of explanatory variables) used in the evaluation of FIG. 9. Accordingly, it can be ascertained that the explanatory variable “pole shape” also does not contribute to improvement of the accuracy of a learning model of machine learning.

According to the above evaluations, it is desirable that the facility data be at least one of the number of years elapsed from when the outside facility was installed, the number of support wires supporting the outside facility, classification representing an arrangement state of the adjacent outside facility, the length of the outside facility, information on an area where the outside facility is installed, and deflection.

The machine learning device 301 performs feature extraction using F-measures in the analysis unit 12 and generates the learning model M1 through learning using one or more pieces of the aforementioned facility data obtained as results of feature extraction as learning parameters and using cracking or corrosion as correct data.

### Embodiment 2

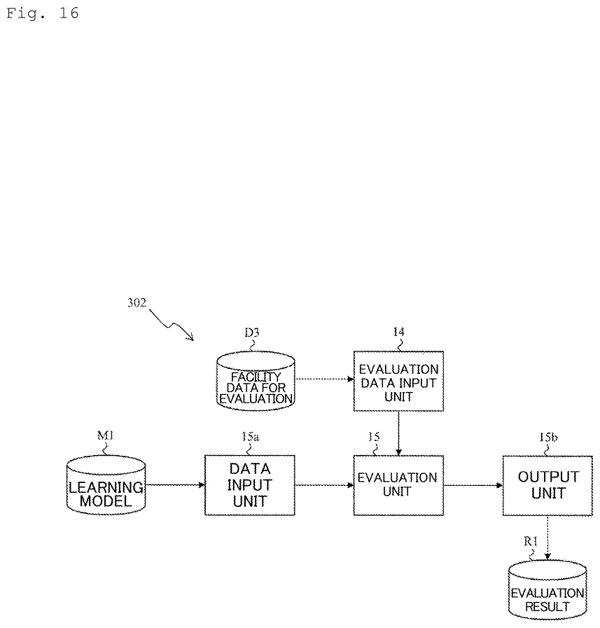

FIG. 16 is a diagram representing a deterioration estimation device 302 of the present embodiment. The deterioration estimation device 302 is a deterioration estimation device in which a computer diagnoses deterioration of a diagnosis target outside facility using a learning model M1 and includes an evaluation data input unit 14 to which facility data D3 for evaluation which represents features and states of the diagnosis target outside facility is input, and an evaluation unit 15 which calculates a probability of deterioration of the diagnosis target outside facility from the facility data D3 for evaluation input to the evaluation data input unit 14 using the learning model M1.

It is desirable that the learning model M1 used by the deterioration estimation device 302 be the learning model generated by the machine learning device 301 described in embodiment 1. That is, the learning model M1 is generated through supervised learning using, as training data, facility data of an outside facility other than the diagnosis target in a deterioration state and facility data of the outside facility other than the diagnosis target which is not in a deterioration state, and the facility data is characterized by being at least one of the number of years elapsed from when the outside facility was installed, the number of support wires supporting the outside facility, classification representing an arrangement state of the adjacent outside facility, the length of the outside facility, information on an area where the outside facility is installed, and deflection.

The deterioration estimation device 302 operates as follows. The evaluation unit 15 reads the learning model M1 input to a data input unit 15a. In addition, the evaluation unit 15 reads information of a utility pole to be evaluated (facility data for evaluation) input to the evaluation data input unit 14 in the form of a facility data structure. The evaluation unit 15 estimates cracking or corrosion of the utility pole to be evaluated using the learning model M1. Here, the evaluation unit 15 uses Naive Bayes, SVM, deep learning and other known machine learning technologies. The evaluation unit 15 outputs an estimated state of the utility pole as a probability (e.g., cracking probability of 35%) through an output unit 15b as an evaluation result R1. Meanwhile, on the basis of an arbitrary threshold value (e.g., cracking probability of 50%), the utility pole may be diagnosed as “deteriorated” when evaluated as a probability equal to or greater than a threshold value and diagnosed as “not deteriorated” when evaluated as a probability less than the threshold value about the evaluation result R1.

### Embodiment 3

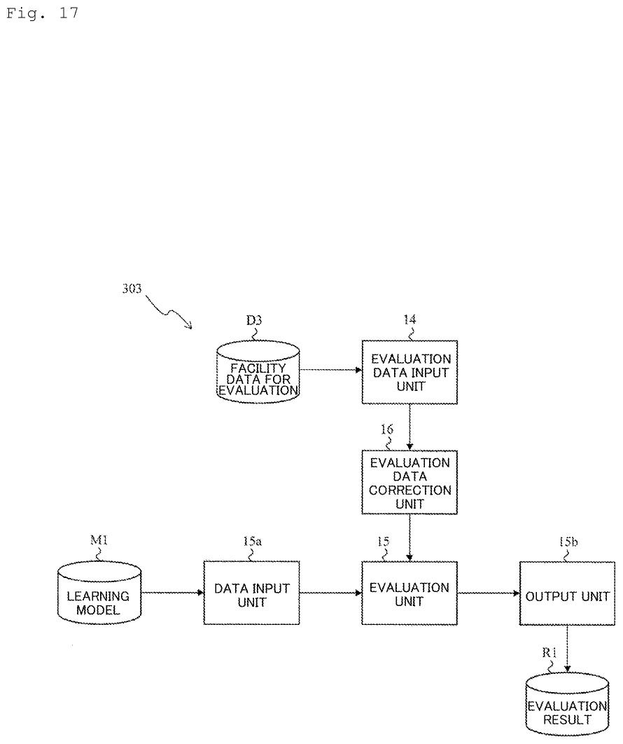

FIG. 17 is a diagram representing a deterioration estimation device 303 of the present embodiment. The deterioration estimation device 303 is characterized by further including an evaluation data correction unit 16 which changes a part of the facility data D3 for evaluation in the deterioration estimation device 302 of embodiment 2.

For example, the evaluation data correction unit 16 adds an arbitrary number n of years to elapsed years of the facility data D3 for evaluation. The deterioration estimation device 303 can estimate a deterioration state after n years by evaluating the facility data D3 for evaluation corrected by the evaluation data correction unit 16 through the evaluation unit 15.

### Embodiment 4

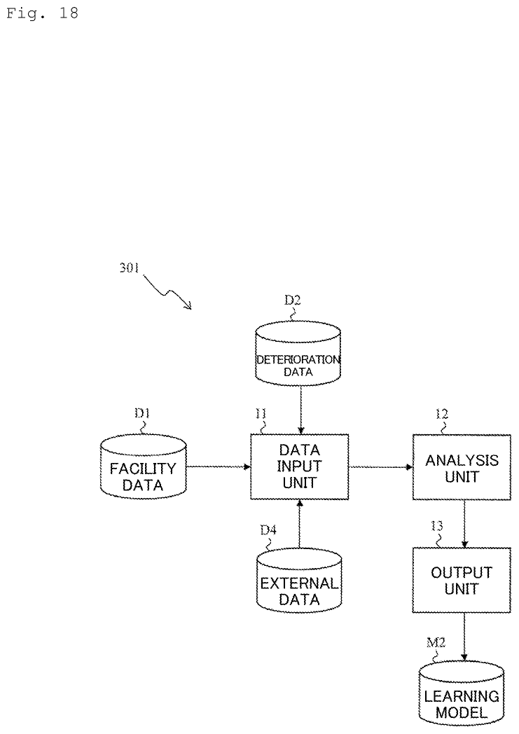

FIG. 18 is a diagram representing a machine learning device 301 of the present embodiment. The machine learning device 301 of the present embodiment differs from the machine learning device 301 of embodiment 1 in that external data D4 other than the facility data D1 and the deterioration data D2 is additionally input to a data input unit 11. The external data D4 may be, for example, weather and ground data. That is, the machine learning device 301 of the present embodiment is characterized in that at least one of weather data and ground data of a position at which the outside facility is installed is additionally input to the input unit 11 as the external data D4 and an analysis unit 12 performs supervised learning additionally using, as the training data, the external data D4 of the outside facility in a deterioration state and the external data D4 of the outside facility that is not in a deterioration state.

Weather data is data from the Meteorological Agency and may be, for example, an average wind velocity (m/s), maximum snowfall (cm), an average temperature (° C.), highest temperature-lowest temperature (° C.), the number of dates having daily lowest temperatures of less than 0° C. (date/month), the sum of rainfalls (mm/month), average humidity (%), and the duration of sunshine (hours/month).

The ground data is data from the National Research Institute for Earth Science and Disaster Prevention and may be, for example, microtopography classification code, an average S-wave velocity at a surface layer of 30 m, and an amplification factor of a maximum velocity at which the surface of the earth is reached from an engineering base (Vs=400 m/s).

The machine learning device 301 operates as follows. The analysis unit 12 reads one or more pieces of the facility data D1 through the data input unit 11. The analysis unit 12 additionally reads the external data D4 such as weather and ground through the data input unit 11. The analysis unit 12 associates corresponding weather data and ground data with each utility pole at a utility pole coordinate position. Meanwhile, with respect to the weather data, an arbitrary number of years (e.g., 10 years) or an average number of years from when utility poles were installed to the present is calculated. The analysis unit 12 performs learning (feature extraction) using this data and presence or absence of cracking or corrosion of the deterioration data D2 as correct data and training data. The analysis unit 12 outputs a learning model M2 generated as a result of learning through an output unit 13.

In addition, although the deterioration estimation device 302 of FIG. 16 or the deterioration estimation device 303 of FIG. 17 can be used as a deterioration estimation device of the present embodiment, it is desirable that at least one of weather data and ground data of the position at which the outside facility is installed be additionally input to the evaluation data input unit 14 as external data.

It is possible to improve the accuracy of an estimation result by adding the external data D4 in addition to the facility data D1.

### Example 1

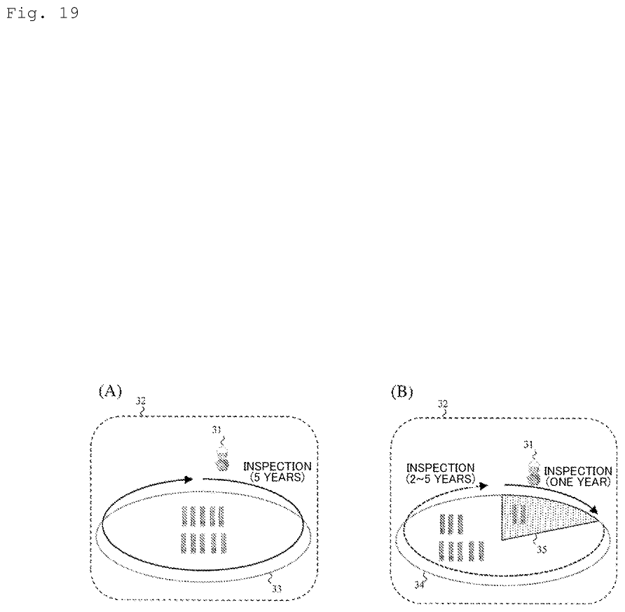

In the present example, effects of the present invention will be described. FIG. 19(A) is a diagram representing a conventional inspection method. In conventional inspection, an inspector 31 goes to a site where utility poles are installed and diagnoses presence or absence of cracking with respect to all utility poles 33 in an inspection area 32. For example, when it is assumed that the number of utility poles that can be diagnosed by the inspector 31 is 2,000 in one year, if 10,000 utility poles 33 are installed in a certain inspection area 32, it takes five years for the inspector 31 to diagnose presence or absence of cracking with respect to all utility poles 33 on the site. Further, in the conventional inspection, utility poles to be diagnosed cannot be estimated in advance because which a utility pole has cracking is not known.

FIG. 19(B) is a diagram representing an inspection method of the present invention. In the present invention, it is possible to output an estimated probability of cracking with respect to utility poles 33. For example, when the deterioration estimation device of the present invention estimates that there are 2,000 utility poles 35 having estimated probabilities of cracking of 0.5 to 1 in an inspection area, the corresponding utility poles can be preferentially inspected. As a result, when an inspection period is set to five years, it is possible to diagnose utility poles having cracking in early stages by inspecting utility poles 35 having estimated probabilities of cracking of 0.5 to 1 for the first year and inspecting utility poles 34 having estimated probabilities of cracking of 0 to 0.5 for the remaining four years (from the second year to the fifth year), to efficiently perform the inspection work. Furthermore, if only utility poles 35 having estimated probabilities of cracking of 0.5 to 1 are diagnosed, the remaining utility poles 34 (having estimated probabilities of cracking of 0 to 0.5) are not diagnosed and thus inspection costs can be reduced.

### Example 2

When the deterioration estimation device includes the evaluation data correction unit 16, as described in embodiment 3, utility poles in which cracking will occur in the future can be predicted. For example, if utility poles in which lateral cracking will occur after 10 years are predicted through the deterioration estimation device, the number of utility poles that are targets to be inspected by an inspector can be decreased and additionally inspection costs can be reduced.

### Example 3

The machine learning device 301 and the deterioration estimation device (302, 303) may be combined, as illustrated in FIG. 7, to construct a deterioration diagnostic apparatus. The deterioration diagnostic apparatus can generate the learning model Ml from past data and perform deterioration diagnosis from newly input facility data for evaluation (data of an outside facility that is a diagnosis target).

[Supplement]

The facility data D1 and facility data D3 for evaluation may include data (qualitative data) that is not a numerical value. For example, public/private classification, pole classification and area information are qualitative data. Such qualitative data is converted into quantitative variables (dummy variables) in machine learning of the analysis unit 12 and the evaluation unit 15. For example, when a public land, a private land, and a boundary are present as in public/private classification, data of

| Utility pole number | public/private classification |
|---|---|
| 1 | public land |
| 2 | private land |
| 3 | private land |
| 4 | public land |
| 5 | boundary |

is converted into 1 (presence) and 0 (absence) in units of variable as follows.

| Utility pole number | public land | private land | boundary |
|---|---|---|---|
| 1 | 1 | 0 | 0 |
| 2 | 0 | 1 | 0 |
| 3 | 0 | 1 | 0 |
| 4 | 1 | 0 | 0 |
| 5 | 0 | 0 | 1 |

In addition, in machine learning of the analysis unit 12 and the evaluation unit 15, a technique called normalization is used in order to match dimensions of numerical value data (quantitative data). Normalization is performed without changing features (dispersion) of original explanatory variables (numerical value data). Meanwhile, the normalization technique depends on a machine learning algorithm employed by the analysis unit 12 and the evaluation unit 15.

### REFERENCE SIGNS LIST

11 Data input unit
12 Analysis unit
13 Output unit
14 Evaluation data input unit
15 Evaluation unit
15a Data input unit
15b Output unit
16 Evaluation data correction unit
301 Machine learning device
302, 303 Deterioration estimation device

1. A machine learning device that generates a learning model by which a computer determines deterioration of an outside facility, the machine learning device comprising:
a processor; and
a storage medium having computer program instructions stored thereon, when executed by the processor, perform to:
receive facility data representing features and states of the outside facility and deterioration data representing presence or absence of deterioration that has occurred in the outside facility; and generates the learning model by performing supervised learning using the facility data of the outside facility in a deterioration state and the facility data of the outside facility that is not in a deterioration state as training data, wherein the facility data is at least one of the number of years elapsed from when the outside facility was installed, the number of support wires supporting the outside facility, classification representing an arrangement state of the adjacent outside facility, the length of the outside facility, and information on an area where the outside facility is installed.

2. The machine learning device according to claim 1, wherein the facility data also includes a deflection of the outside facility, wherein the deflection is a displacement at a position higher than a predetermined height from a ground between a central axis obtained by approximating center points of the outside facility acquired at heights from the ground which are obtained from 3-dimensional coordinates of a surface of the outside facility to a 3-dimensional curve and a reference axis obtained by approximating the center points from the ground to the predetermined height to a straight line.

3. The machine learning device according to claim 1, wherein at least one of weather data and ground data of a position at which the outside facility is installed is input as external data, and the computer program instructions performs supervised learning using the external data of the outside facility in a deterioration state and the external data of the outside facility that is not in a deterioration state as the training data.

4. A deterioration estimation device in which a computer diagnoses deterioration of a diagnosis target outside facility using a learning model, the deterioration estimation device comprising:
a processor; and
a storage medium having computer program instructions stored thereon, when executed by the processor, perform to:
receive facility data for evaluation representing features and states of the diagnosis target outside facility; and calculates a probability of deterioration of the diagnosis target outside facility from the facility data using the learning model, wherein the learning model is generated through supervised learning using facility data of an outside facility other than the diagnosis target in a deterioration state and facility data of the outside facility other than the diagnosis target which is not in a deterioration state as training data, and the facility data is at least one of the number of years elapsed from when the outside facility was installed, the number of support wires supporting the outside facility, classification representing an arrangement state of the adjacent outside facility, the length of the outside facility, and information on an area where the outside facility is installed.

5. The deterioration estimation device according to claim 4, wherein the facility data also includes a deflection of the outside facility, wherein the deflection is a displacement at a position higher than a predetermined height from a ground between a central axis obtained by approximating center points of the outside facility acquired at heights from the ground which are obtained from 3-dimensional coordinates of a surface of the outside facility to a third-order curve and a reference axis obtained by approximating the center points from the ground to the predetermined height to a straight line.

6. The deterioration estimation device according to claim 4, wherein at least one of weather data and ground data of a position at which the outside facility is installed is input to the evaluation data input unit as external data, and the learning model is generated through supervised learning using the external data of the outside facility in a deterioration state and the external data of the outside facility that is not in a deterioration state as the training data.

7. (canceled)
